(19) United States
(12) Patent Application Publication
(10) Pub. No.: US 2026/0321535 A1
(43) Pub. Date: Oct. 15, 2026

(54) ELECTRIC CIRCUIT BREAKER DEVICE

(71) Applicant: Daicel Corporation, Osaka (JP)

(72) Inventors: Toshiyuki SAKAI, Tokyo (JP); Tomohide FUJIWARA, Tokyo (JP)

(73) Assignee: Daicel Corporation, Osaka (JP)

(21) Appl. No.: 19/108,446

(22) PCT Filed: Jun. 13, 2023
(86) PCT No.: PCT/JP2023/021919

§ 371 Date: Mar. 4, 2025

(30) Foreign Application Priority Data
Sep. 6, 2022 (JP) 2022-141597

(51) Int. Cl. H01H 39/00; H01H 9/30

(52) U.S. Cl. CPC H01H 39/006; H01H 9/302

(57) ABSTRACT

Provided is an electric circuit breaker device used in a high-voltage electric circuit, the electric circuit breaker device including: an igniter provided in a housing; a projectile configured to be projected, by energy received from the igniter, in a predetermined projecting direction along an accommodating space within the housing; a pair of current-carrying portions disposed such that the pair of current-carrying portions are electrically connected to each other and electrical connection is disconnected when the projectile is projected at a time of actuation of the igniter; and an arc-extinguishing material disposed in a predetermined region.

### TECHNICAL FIELD

The present invention relates to an electric circuit breaker device.

### BACKGROUND ART

An electric circuit may be provided with a breaker device that is actuated when an abnormality occurs in a device constituting the electric circuit or when an abnormality occurs in a system on which the electric circuit is mounted, thereby urgently interrupting the conduction of electricity in the electric circuit. As one aspect thereof, there has been proposed an electric circuit breaker device configured to separate a conductive metal from a part of an electric circuit by energy imparted by an igniter or the like, thereby interrupting the electric circuit (see, for example, Patent Document 1). Further, in recent years, electric circuit breaker devices applied to electric vehicles equipped with a high-voltage power source have become increasingly important.

### CITATION LIST

### Patent Document

Patent Document 1: JP 2009-99559 A

### SUMMARY OF INVENTION

### Technical Problem

In an actual electric circuit breaker device, an arc is likely to occur when a conductor forming a part of an electric circuit is separated. When an arc occurs, the electric circuit cannot be interrupted quickly, and thus the electric circuit breaker device is required to quickly extinguish the generated arc.

In addition, at a time of actuation of the electric circuit breaker device, the gas generated from the igniter or the like is at a high temperature and is often ionized. The conductive metal portion is often coated with the generated high-temperature gas, and even if the conductive metal is separated, the separated conductive metal may be coated with the ionized gas, resulting in electrical conduction.

The technique of the present disclosure has been made in view of the circumstances described above, and an object thereof is to provide an electric circuit breaker device that can quickly extinguish an arc that occurs at a time of actuation.

### Solution to Problem

For the purpose of solving the problems described above, an electric circuit breaker device according to the present disclosure includes: a housing; an igniter provided inside the housing; a first accommodating space formed inside the housing and extending in one direction; a projectile including a conductive member having electrical conductivity, the projectile being positioned at a first position within the first accommodating space before actuation of the igniter and configured to be projected in a predetermined projecting direction along the first accommodating space by energy received from the igniter at a time of actuation of the igniter; and a pair of current-carrying portions provided inside the housing and forming a part of an electric circuit, the pair of current-carrying portions being disposed such that the pair of current-carrying portions are electrically connected via the conductive member of the projectile positioned at the first position before actuation of the igniter, and electrical connection is disconnected when the igniter is actuated and the projectile is projected; and an arc-extinguishing material disposed in a predetermined region before actuation of the igniter, wherein the electric circuit breaker device is configured such that, at a time of actuation of the igniter, the arc-extinguishing material is released from the predetermined region by an impact caused when the projectile is projected, and at least a part of the projectile is covered with the arc-extinguishing material that is released.

In addition, the electric circuit breaker device according to the present disclosure may include: a second accommodating space formed, as the predetermined region, outside the first accommodating space and provided inside the housing; and a first communicating portion via which the first accommodating space and the second accommodating space are in communication with each other, wherein the first communicating portion is closed by the projectile positioned at the first position before actuation of the igniter, and the first communicating portion opens when the projectile is projected by actuation of the igniter, and the arc-extinguishing material is released from the second accommodating space to the first accommodating space.

In addition, the electric circuit breaker device according to the present disclosure may further include a second communicating portion via which the second accommodating space and a region of the first accommodating space on a frontward side of the projectile in the projecting direction are in communication with each other.

In addition, when the projectile is projected by actuation of the igniter, the arc-extinguishing material may be accommodated in a region of the first accommodating space on a rearward side of the projectile in the projecting direction.

In addition, the pair of current-carrying portions may be disposed apart from each other in the projecting direction, a first current-carrying portion of the pair of current-carrying portions on the rearward side in the projecting direction may have a first socket having a tubular shape and extending along the projecting direction, a second current-carrying portion of the pair of current-carrying portions on the front side in the projecting direction may have a second socket having a tubular shape and extending along the projecting direction, the first accommodating space is defined by the first socket and the second socket, and before actuation of the igniter, the projectile may be fitted into the first socket and the second socket such that the first socket and the second socket are electrically connected via the conductive member.

Before actuation of the igniter, the conductive member may be press-fitted into at least one of the first socket or the second socket.

Before actuation of the igniter, the conductive member may be bonded to at least one of the first socket or the second socket.

Before actuation of the igniter, at least one of the first socket or the second socket may be integrally connected to the conductive member.

In addition, the projectile may include a piston disposed on the rearward side of the conductive member in the projecting direction and configured to be projected in the projecting direction by energy received from the igniter at a time of actuation of the igniter.

In addition, the predetermined region may be included in the piston.

The arc-extinguishing material may be formed of an inorganic oxide.

Further, the arc-extinguishing material may be formed of zeolite.

### Advantageous Effects of Invention

According to the present disclosure, it is possible to provide an electric circuit breaker device that can quickly extinguish an arc that occurs at a time of actuation.

### BRIEF DESCRIPTION OF DRAWINGS

FIG. 1 is a longitudinal cross-sectional view illustrating a state before actuation of an electric circuit breaker device according to an embodiment.

FIG. 2 is a longitudinal cross-sectional view for explaining an internal space of a breaker device according to the embodiment.

FIG. 3 is a longitudinal cross-sectional view illustrating a state after actuation of the electric circuit breaker device according to the embodiment.

FIG. 4 is a longitudinal cross-sectional view of an electric circuit breaker device according to Modified Example 1 of the embodiment.

FIG. 5 is a longitudinal cross-sectional view of an electric circuit breaker device according to Modified Example 2 of the embodiment.

FIG. 6 is a longitudinal cross-sectional view of an electric circuit breaker device according to Modified Example 3 of the embodiment.

### DESCRIPTION OF EMBODIMENTS

### Embodiment

### Device Configuration

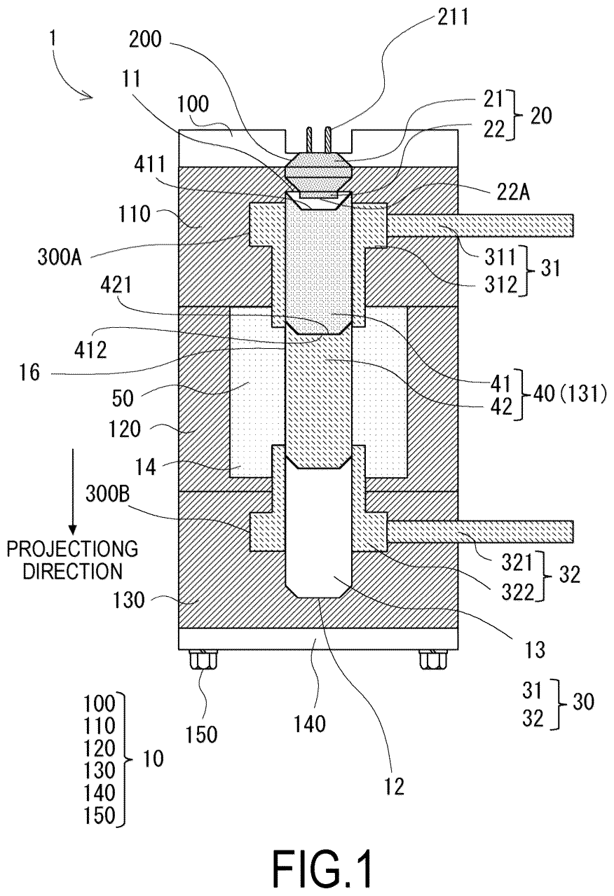

FIG. 1 is a longitudinal cross-sectional view illustrating a state before actuation of an electric circuit breaker device (hereinafter, simply referred to as a “breaker device”) 1 according to an embodiment. FIG. 1 illustrates a state before actuation of the breaker device 1. The breaker device 1 is a device that interrupts an electric circuit included in a vehicle, an electric home appliance, or the like when an abnormality occurs in the electric circuit or in a system including a battery (lithium ion battery, for example) of the electric circuit, thereby preventing great damage, for example. In the present specification, a cross section along a height direction (i.e., a vertical direction in which a first accommodating space 13 described later extends) illustrated in FIG. 1 is referred to as a longitudinal cross section of the breaker device 1, and a cross section orthogonal to the longitudinal cross section is referred to as a transverse cross section of the breaker device 1. In addition, a direction in which a projectile 40 described below is projected along the first accommodating space 13 is referred to as a projecting direction. As illustrated in FIG. 1, in the present embodiment, the direction toward the lower side in the height direction (downward direction) is the projecting direction. However, in the present specification, the vertical direction of the breaker device 1 merely indicates a relative positional relationship among the elements in the breaker device 1 for convenience of description of the embodiment.

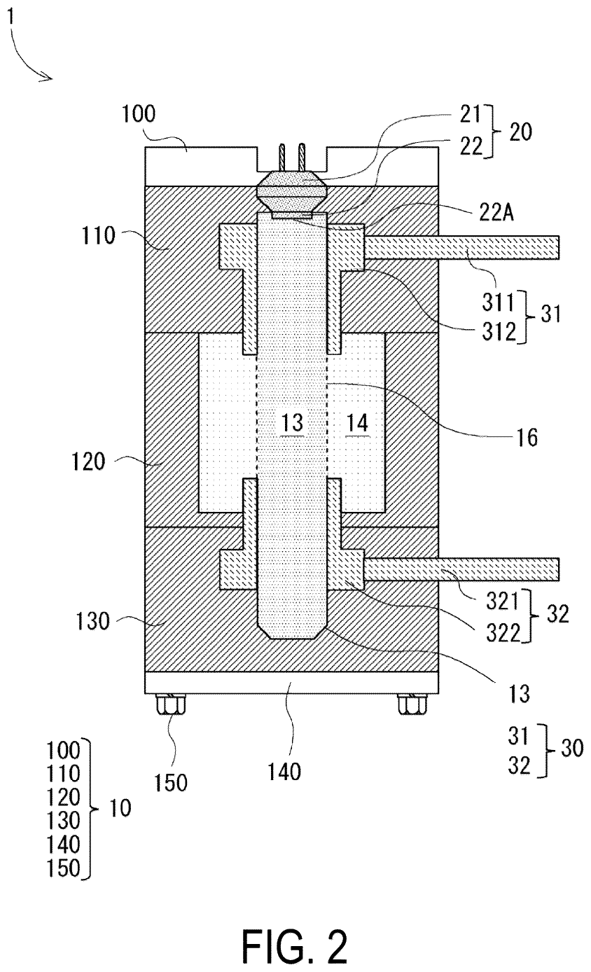

The breaker device 1 includes a housing 10, an igniter 20, a current-carrying portion 30, a projectile 40, an arc-extinguishing material 50, and the like. The housing 10 includes a first accommodating space 13 extending in the vertical direction from a first end portion 11 on the upper end side to a second end portion 12 on the lower end side. FIG. 2 is a longitudinal cross-sectional view for explaining an internal space of the breaker device 1 according to a first embodiment. In FIG. 2, the projectile 40 and the arc-extinguishing material 50 are not illustrated. As illustrated in FIG. 2, the first accommodating space 13 is a columnar space formed in a linear shape in which the projectile 40 is movable, and the first accommodating space 13 extends along the vertical direction of the breaker device 1. The housing 10 further includes a second accommodating space 14 laterally outward from the first accommodating space 13. The second accommodating space 14 is an annular space surrounding the first accommodating space 13, and is formed as an example of a “predetermined region” according to the present disclosure. As illustrated in FIG. 1, the arc-extinguishing material 50 is accommodated in the second accommodating space 14. In the aspect illustrated in FIG. 1, the projectile 40 is accommodated in the first accommodating space 13 formed inside the housing 10, and the arc-extinguishing material 50 is accommodated in the second accommodating space 14 defined as the predetermined region. A first communicating portion 16 via which the first accommodating space 13 and the second accommodating space 14 are in communication with each other is formed between the first accommodating space 13 and the second accommodating space 14. Although details will be described later, the first communicating portion 16 is closed by the projectile 40 positioned at a first position 131 in the first accommodating space 13 in the initial state before actuation of the breaker device 1 (igniter 20), and after actuation of the breaker device 1 (igniter 20), the projectile 40 is projected in the projecting direction, thereby opening the first communicating portion 16, and the arc-extinguishing material 50 is released from the second accommodating space 14 to the first accommodating space 13 by impact due to the projecting.

### Housing

The housing 10 includes a housing plate 100, a first housing 110, a second housing 120, a third housing 130, and a base plate 140. The first housing 110, the second housing 120, the third housing 130, and the base plate 140 are vertically joined to the housing plate 100 by a bolt 150, thereby forming the housing 10 as one body.

The housing 10 has, for example, an outer shape of substantially prismatic columnar shape. However, the shape of the housing 10 is not particularly limited. A cylindrical columnar cavity portion is formed along the vertical direction in each of the first housing 110, the second housing 120, and the third housing 130 included in the housing 10. In an upper portion of the housing 10, an igniter accommodating portion 200 is formed by the housing plate 100 and the first housing 110, and the igniter 20 described below is disposed in the igniter accommodating portion 200. The first housing 110 is configured to allow a first current-carrying portion 31 to be disposed therein, and the third housing 130 is configured to allow a second current-carrying portion 32 to be disposed therein. In the housing 10 according to the embodiment, a pair of a first holding hole 300A and a second holding hole 300B are formed. The first holding hole 300A and the second holding hole 300B are formed inside the housing 10 and extend in the vertical direction, and the first housing 110, the second housing 120, and the third housing 130 configured as described above can be formed of, for example, an insulating member such as a synthetic resin. For example, they may be formed of a nylon which is a kind of poly amide synthetic resin.

The housing plate 100 is provided with a female screw at each of four corners, and the first housing 110, the second housing 120, and the third housing 130 are also provided with a hole through which the bolt 150 can be inserted from the base plate 140 side, and the housing plate 100, the first housing 110, the second housing 120, the third housing 130, and the base plate 140 can be joined to each other by sandwiching the first housing 110, the second housing 120, and the third housing 130 by the housing plate 100 and the base plate 140 and by fastening the bolt 150 to the female screw provided in the housing plate 100. The housing plate 100 configured as described above can be formed of, for example, an appropriate member made of a metal, such as stainless steel or aluminum, which is excellent in strength and durability. However, the material forming the housing plate 100 is not particularly limited. Regarding the shape of the housing plate 100, the aspect set forth above is merely an example thereof, and other shapes may be adopted.

The base plate 140 is also formed of a metal material. For example, the base plate 140 can be formed of an appropriate member made of a metal, such as stainless steel or aluminum, which is excellent in strength and durability. However, a material for forming the base plate 140 is not particularly limited. Regarding the shape of the base plate 140, the aspect set forth above is merely an example thereof, and other shapes may be adopted.

### Igniter

Next, the igniter 20 will be described. The igniter 20 is an electric igniter including an igniter main body 21 including a pair of conductive pins 211 and an ignition portion 22 including an ignition charge. The igniter main body 21 is surrounded by, for example, an insulating resin. In addition, the distal ends of the pair of conductive pins 211 of the igniter main body 21 are exposed to the outside, and are to be connected to a power supply when the breaker device 1 is in use.

The igniter 20 includes the ignition portion 22 and the igniter main body 21 accommodated in the igniter accommodating portion 200 formed by the first housing 110 and the housing plate 100. The igniter 20 is fixed so as to be sandwiched between the housing plate 100 and the first housing 110 when joining them. In addition, an O-ring installation groove may be formed, in an igniter installation surface 111 of the first housing 110, in an annular shape along the circumferential direction of the igniter main body 21, and an O-ring may be fitted into this groove portion. The O-ring may be formed of, for example, rubber (such as silicone rubber) or synthetic resin, and may function to enhance airtightness between the inner peripheral surface of the igniter accommodating portion 200 and the igniter main body 21.

As illustrated in FIG. 1, the ignition portion 22 of the igniter 20 is disposed at the upper end portion (first end portion 11) of the first accommodating space 13 of the housing 10 and faces the first accommodating space 13. For example, the ignition portion 22 is configured to accommodate an ignition charge in an igniter cup. For example, the ignition charge is accommodated in the igniter cup of the ignition portion 22 in a state of being in contact with a bridge wire (resistor) bridged between and connecting the proximal ends of the pair of conductive pins 211. As the ignition charge, for example, zirconium-potassium perchlorate (ZPP), zirconium-tungsten-potassium perchlorate (ZWPP), titanium hydride-potassium perchlorate (THPP), lead tricinate, or the like may be adopted.

In actuation of the igniter 20, when an actuating current to ignite the ignition charge is supplied from a power source to the conductive pins 211, heat is produced by the bridge wire in the ignition portion 22, and as a result, the ignition charge in the igniter cup is ignited and burned, thereby generating a combustion gas. Then, the pressure in the igniter cup increases with the combustion of the ignition charge in the igniter cup of the ignition portion 22, and a rapture surface 22A of the ignition portion 22 is ruptured, and the combustion gas is released from the igniter cup to the first accommodating space 13. More specifically, the combustion gas from the igniter cup is released toward a dent portion 411 in a piston 41 included in the projectile 40 disposed at the first position 131 within the first accommodating space 13.

### Current-Carrying Portion

Next, the current-carrying portion 30 will be described. The current-carrying portion 30 is a conductive metal body forming a part of a predetermined electric circuit when the breaker device 1 is attached to this electric circuit. The current-carrying portion 30 includes a pair of a first current-carrying portion 31 and a second current-carrying portion 32 that are disposed apart from each other in the vertical direction (i.e., the projecting direction).

As illustrated in FIG. 1, the first current-carrying portion 31 includes a first bus bar 311 and a first socket 312. The second current-carrying portion 32 includes a second bus bar 321 and a second socket 322. The first socket 312 and the second socket 322 each are formed in a tubular shape extending in the vertical direction, the first socket 312 is disposed in the first holding hole 300A, and the second socket 322 is disposed in the second holding hole 300B. The first bus bar 311 and the second bus bar 321 each are formed in a strip, the first bus bar 311 extends laterally from the first socket 312 and protrudes to the outside of the housing 10, and the second bus bar 321 extends laterally from the second socket 322 and protrudes to the outside of the housing 10. The portions of the first bus bar 311 and the second bus bar 321 protruding to the outside of the housing 10 are to be connected to another conductor (i.e., a lead wire) in the above-described electric circuit.

The current-carrying portion 30 can be formed of, for example, a metal such as copper (Cu). However, the current-carrying portion 30 may be formed of a metal other than copper, or may be formed of an alloy of copper and another metal.

However, the current-carrying portion 30 can take various forms, and its shape is not particularly limited.

### Accommodating Space

As illustrated in FIG. 2, the first accommodating space 13 is defined by the igniter 20, the first housing 110, the second housing 120, the third housing 130, the first socket 312, and the second socket 322. The upper end portion (first end portion 11) of the first accommodating space 13 is constituted by the igniter 20, and the lower end portion (second end portion 12) of the first accommodating space 13 is constituted by the third housing 130. The first accommodating space 13 is formed in a cylindrical columnar shape including the internal space of the first socket 312, the central portion of the cavity portion of the second housing 120, and the internal space of the second socket 322.

Laterally outward of the first accommodating space 13, the second accommodating space 14 as the predetermined region in which the arc-extinguishing material 50 described below is disposed is formed in an annular shape and surrounds the first accommodating space 13. The second accommodating space 14 is formed by a portion of the cavity portion of the second housing 120 excluding the central portion thereof (i.e., a portion included in the first accommodating space 13). In the initial state before actuation illustrated in FIG. 1, the second accommodating space 14 is defined by the projectile 40 positioned at the first position 131 and the second housing 120. As illustrated in FIG. 2, the first accommodating space 13 and the second accommodating space 14 communicate with each other via the first communicating portion 16. The first communicating portion 16 is constituted by an annular gap formed between the first socket 312 and the second socket 322.

### Projectile

Next, the projectile 40 will be described with reference to FIG. 1. The projectile 40 includes the piston 41 and a rod 42 that is a conductive member installed in contact with the piston 41, and is disposed in the first accommodating space 13. The piston 41 is formed of, for example, an insulating member such as a synthetic resin. The rod 42 is formed of a conductive member such as copper. As illustrated in FIG. 1, within the first accommodating space 13, the piston 41 is disposed closer to the first end portion 11 than the rod 42 (on the rearward side in the projecting direction). Note that the entirety of the rod 42 is not necessarily formed of a conductive member as long as the first socket 312 and the second socket 322 can be electrically connected to each other in the initial state before actuation, and the aspect may be appropriately changed. For example, the rod 42 may have a configuration in which a non-conductive member is coated with a copper foil. This configuration makes it possible to minimize the amount of the conductive member used for the rod 42, and weight reduction and cost reduction can be achieved.

In FIG. 1, the piston 41 and the rod 42 each have a substantially cylindrical columnar shape and have an outer diameter substantially corresponding to the inner diameter of the first accommodating space 13. In addition, on the top surface of the piston 41 in the projectile 40, for example, the dent portion 411 that is a recessed portion having a cylindrical columnar shape is formed, and this dent portion 411 is configured such that the ignition portion 22 can be received. The bottom surface of the dent portion 411 is formed as a pressure receiving portion that receives energy from the igniter 20 at a time of actuation of the igniter 20. An attachment protrusion 412 to which the rod 42 is attached is provided on the lower end side of the piston 41. Furthermore, an attachment recess 421 into which the attachment protrusion 412 of the piston 41 is fitted is provided on the upper end side of the rod 42. However, the piston 41 and the rod 42 may be bonded with an adhesive or the like, or may be formed by integral molding.

In the initial state before actuation as illustrated in FIG. 1, the projectile 40 configured as described above is disposed at the first position 131 in the first accommodating space 13 in a state where the attachment protrusion 412 of the piston 41 is fitted into and attached to the attachment recess 421 of the rod 42. In the example illustrated in FIG. 1, the piston 41 of the projectile 40 is positioned in the first accommodating space 13 on the igniter 20 side (upper end side). In addition, in the example illustrated in FIG. 1, the rod 42 of the projectile 40 is held in a state where the rod 42 is inserted through the first socket 312 included in the first current-carrying portion 31 of the current-carrying portion 30 and through the second socket 322 included in the second current-carrying portion 32. The rod 42 is fitted with both ends held by the first socket 312 of the first current-carrying portion 31 and the second socket 322 of the second current-carrying portion 32. Accordingly, in the initial state before actuation, the first socket 312 and the second socket 322 included in the current-carrying portion 30 and the rod 42 make a circuit conductive and are electrically connected. However, the rod 42 included in the projectile 40 may be installed in any mode exemplified by fitting, press-fitting, bonding, or the like to at least one of the first socket 312 or the second socket 322, or the rod 42 may be integrally connected to at least one of the first socket 312 or the second socket 322.

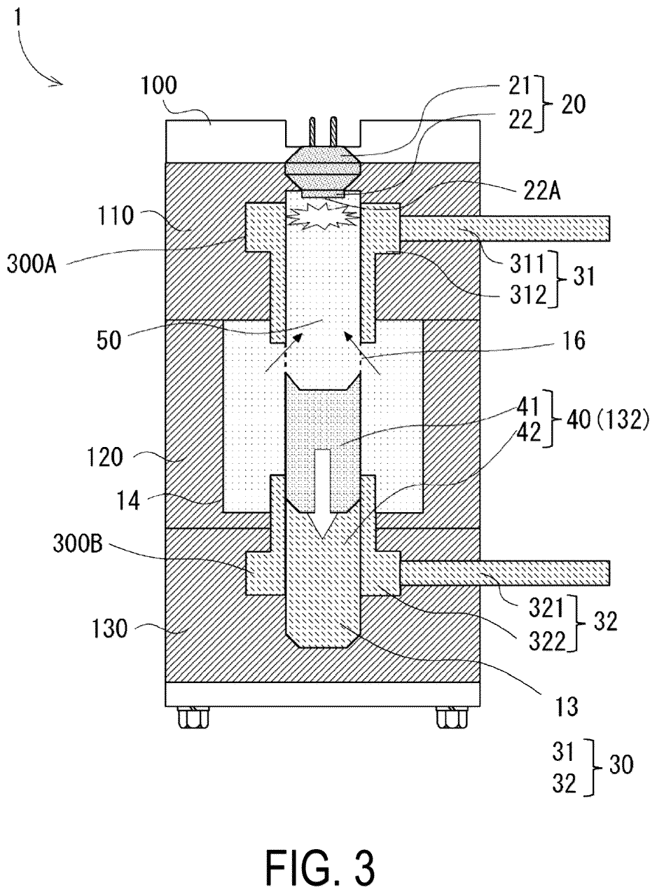

In the initial state before actuation of the breaker device 1 as illustrated in FIG. 1, since the projectile 40 is positioned at the first position 131 and, in the second housing 120, a portion defining the first accommodating space 13 is filled with the projectile 40, the second accommodating space 14 is defined. In the state after actuation of the breaker device 1 (igniter 20) as illustrated in FIG. 3, the projectile 40 moves to a second position 132 that is a position separated in a direction toward the second end portion 12, which is lower in the projecting direction than the first position 131, in the first accommodating space 13.

### Arc-Extinguishing Material

Next, the arc-extinguishing material 50 disposed in the second accommodating space 14 in the housing 10 will be described. The arc-extinguishing material 50 is a coolant that removes an arc that occurs when the electrical connection between the rod 42 and the first socket 312 and the second socket 322 is disconnected and the thermal energy of the current-carrying portion 30 and the rod 42 to cool down each portion, suppressing an arc that occurs when the current is interrupted, or quenching (extinguishing) the generated arc. In the initial state before actuation of the breaker device 1 as illustrated in FIG. 1, the arc-extinguishing material 50 is disposed in the second accommodating space 14. In contrast, in a state after actuation of the breaker device 1 (igniter 20) as illustrated in FIG. 3, the projectile 40 is moved to the second position 132, and the arc-extinguishing material 50 is accommodated into a region within the first accommodating space 13 on the rearward side (on the first end portion 11 side) of the projectile 40 in the projecting direction of the projectile 40. However, the region within the first accommodating space 13 on the rearward side (on the first end portion 11 side) of the projectile 40 in the projecting direction of the projectile 40 may be filled with the arc-extinguishing material 50.

The arc-extinguishing material 50 is released from the second accommodating space 14 to the first accommodating space 13 via the first communicating portion 16 at a time of actuation of the breaker device 1 (igniter 20). As one aspect of the embodiment, the arc-extinguishing material 50 is powdery zeolite. The above-mentioned aspect of the arc-extinguishing material 50 is an example, and no limitation is intended. For example, the arc-extinguishing material 50 may be made of an inorganic oxide and may be granular. The arc-extinguishing material 50 may be not in a solid state, but may be a fluid substance as typified by a liquid, a gel, or the like.

### Operation

Next, the operation of the breaker device 1 of the embodiment will be described. FIG. 1 illustrates a state before actuation of the breaker device 1 according to the embodiment, and FIG. 3 illustrates a state after actuation thereof. Hereinafter, with reference to FIGS. 1 and 3, operation details at a time of actuation of the breaker device 1 will be described.

As illustrated in FIG. 1, before actuation of the breaker device 1, the projectile 40 is positioned at the first position 131. Since the projectile 40 is disposed at the first position 131, the first socket 312 of the first current-carrying portion 31 and the second socket 322 of the second current-carrying portion 32 are electrically connected via the rod 42, and electrical conduction is secured in the electric circuit. In addition, the first communicating portion 16 is closed by the projectile 40 disposed at the first position 131. Therefore, in the initial state before actuation, the arc-extinguishing material 50 is held in the second accommodating space 14.

When the breaker device 1 is actuated into the state illustrated in FIG. 3, the projectile 40 moves to the second position 132.

More specifically, by the operation of the igniter 20, the dent portion 411 of the piston 41 receives the energy from the gas discharged through the rapture surface 22A of the ignition portion 22 included in the igniter 20, and the projectile 40 is projected in the projecting direction and moves from the first position 131 to the second position 132 within the first accommodating space 13. That is, the piston 41 included in the projectile 40 is projected in the projecting direction by the energy received from the igniter 20 at a time of actuation of the igniter 20, and the projectile 40 moves from the first position 131 to the second position 132, and this interrupts the electric circuit electrically connected to the current-carrying portion 30 and the rod 42 included in the projectile 40. At this time, since the projectile 40 moves from the first position 131, the first communicating portion 16 via which the first accommodating space 13 and the second accommodating space 14 are in communication with each other opens. Furthermore, since an impact caused by the projecting of the projectile 40 acts on the arc-extinguishing material 50 disposed in the second accommodating space 14, the arc-extinguishing material 50 disposed in the second accommodating space 14 is released into the first accommodating space 13 via the first communicating portion 16. Since the arc-extinguishing material 50 is released into the first accommodating space 13, and, by the released arc-extinguishing material 50, at least a part of the projectile 40 is covered with the arc-extinguishing material 50, rapid extinction of an arc and rapid cooling of the high-temperature gas generated from the igniter 20 take place. In addition, the arc-extinguishing material 50 is accommodated in a region within the first accommodating space 13 on the rearward side of the projectile 40 in the projecting direction from the second accommodating space 14 after passing through the first communicating portion 16, thereby restraining the projectile 40 from returning from the second position 132 to the first position 131 and maintaining the insulating state.

### Actions and Effects

As described above, according to the breaker device 1 of the present embodiment, it is possible to provide an electric circuit breaker device that can rapidly quench an arc even when an arc occurs during interruption of an electric circuit when an abnormality occurs in a device included in the electric circuit or when an abnormality occurs in a system incorporating the electric circuit. Furthermore, the high-temperature gas generated from the igniter can be rapidly cooled.

### Modified Example 1 of Embodiment

### Device Configuration

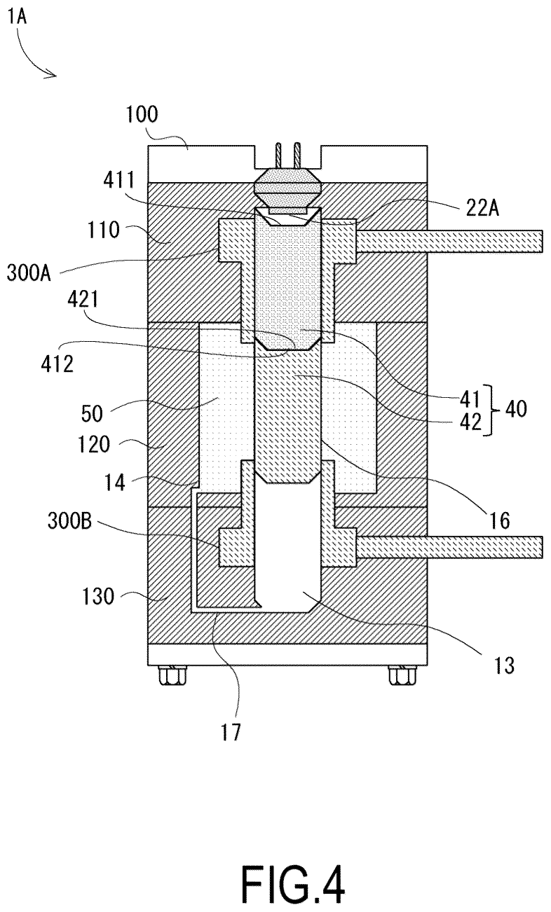

FIG. 4 is a longitudinal cross-sectional view of a breaker device 1A according to Modified Example 1 of the embodiment. FIG. 4 illustrates a schematic structure of the breaker device 1A from a lateral view. Hereinafter, the breaker device 1A according to Modified Example 1 of the embodiment will be described with reference to FIG. 4. Note that, in the description of the present Modified Example, description will be given of differences from the breaker device 1 described with reference to FIGS. 1 to 3. In addition, among members included in the breaker device 1A, the same members as those of the breaker device 1 are denoted by the same reference numerals, and detailed descriptions thereof will be omitted.

As illustrated in FIG. 4, in addition to the configuration of the breaker device 1, the breaker device 1A according to Modified Example 1 includes a second communicating portion 17 in which air or an arc-extinguishing material 50 is movable in the second housing 120 and the third housing 130. The second accommodating space 14 and a front end region of the projectile 40 within the first accommodating space 13 in the projecting direction (region on the second end portion 12 side) are in communication with each other via the second communicating portion 17.

Accordingly, as will be described later, at a time of actuation of the breaker device 1A, an improved actuation speed of the projectile 40 and an effect contributing to diffusion and release of the arc-extinguishing material 50 can be expected.

### Operation

In the breaker device 1A configured as described above, when the igniter 20 is operated, the projectile 40 is projected in the projecting direction by the energy from the igniter 20. At this time, since air existing in the front end region of the projectile 40 within the first accommodating space 13 in the projecting direction (region on the second end portion 12 side) is pushed, by the projectile 40, towards the second communicating portion 17, the air is sent into the second accommodating space 14.

Due to this operation, the second communicating portion 17 functions as a vent hole for air that can be a resistance to the movement of the projectile 40, and furthermore, the arc-extinguishing material 50 readily passes through the first communicating portion 16. This makes the release of the arc-extinguishing material 50 into the first accommodating space 13 more active, which makes it possible to provide an even more reliable operation and/or to increase the operating speed of the breaker device 1A. Note that an opening in the second communicating portion 17 on the first accommodating space 13 side or an opening in the second communicating portion 17 on the second accommodating space 14 side may be closed by a rupture plate formed of, for example, a metal foil, which is ruptured by actuation of the igniter 20.

Providing the rupture plate can prevent the arc-extinguishing material 50 from unintentionally flowing into the second communicating portion 17 before actuation of the igniter 20. In addition, the aspect illustrated in FIG. 3 is an example, and the aspect of the second communicating portion 17 in the breaker device 1A is not limited thereto.

### Modified Example 2 of Embodiment

### Device Configuration

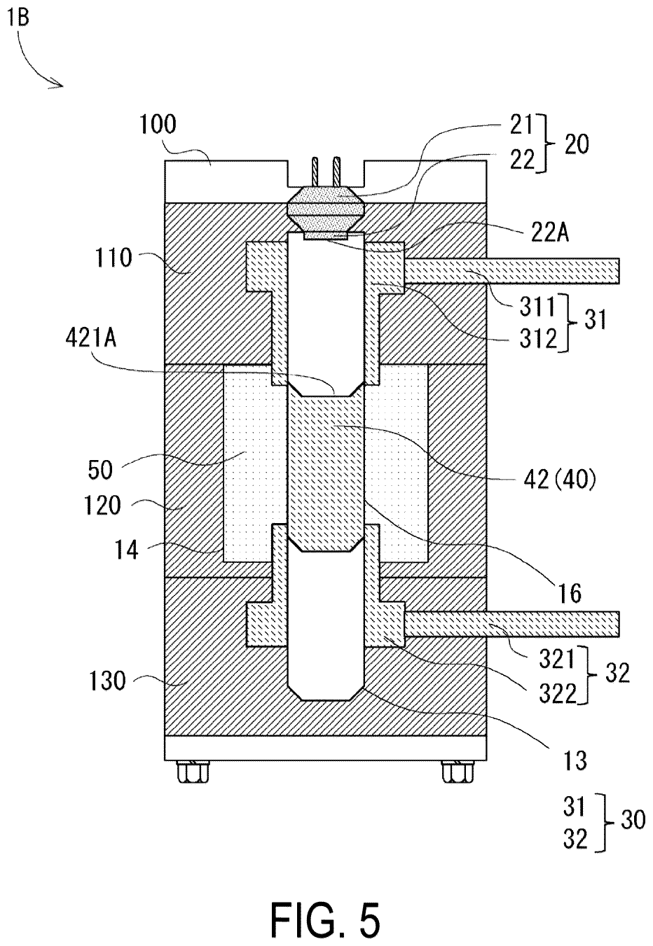

FIG. 5 is a longitudinal cross-sectional view of a breaker device 1B according to Modified Example 2 of the embodiment. FIG. 5 illustrates a schematic structure of the breaker device 1B from a lateral view. Hereinafter, the breaker device 1B according to Modified Example 2 of the embodiment will be described with reference to FIG. 5. Note that, in the description of the present Modified Example, description will be given of differences from the breaker device 1 described with reference to FIGS. 1 to 3. In addition, among members included in the breaker device 1B, the same members as those of the breaker device 1 are denoted by the same reference numerals, and the detailed description thereof will be omitted.

In the breaker device 1B according to Modified Example 2, the projectile 40 includes only the rod 42. A dent portion 421A of the rod 42 receives energy due to gas released from the rapture surface 22A of the ignition portion 22 included in the igniter 20.

### Operation

In the breaker device 1B configured as described above, the projectile 40 is configured only by the rod 42 that is a conductive member, and at a time of actuation of the igniter 20, the dent portion 421A of the rod 42 on the igniter side receives the energy generated by the igniter 20 so that the current-carrying portion 30 and the rod 42 is disconnected, and the electric circuit is interrupted.

### Modified Example 3 of Embodiment

### Device Configuration

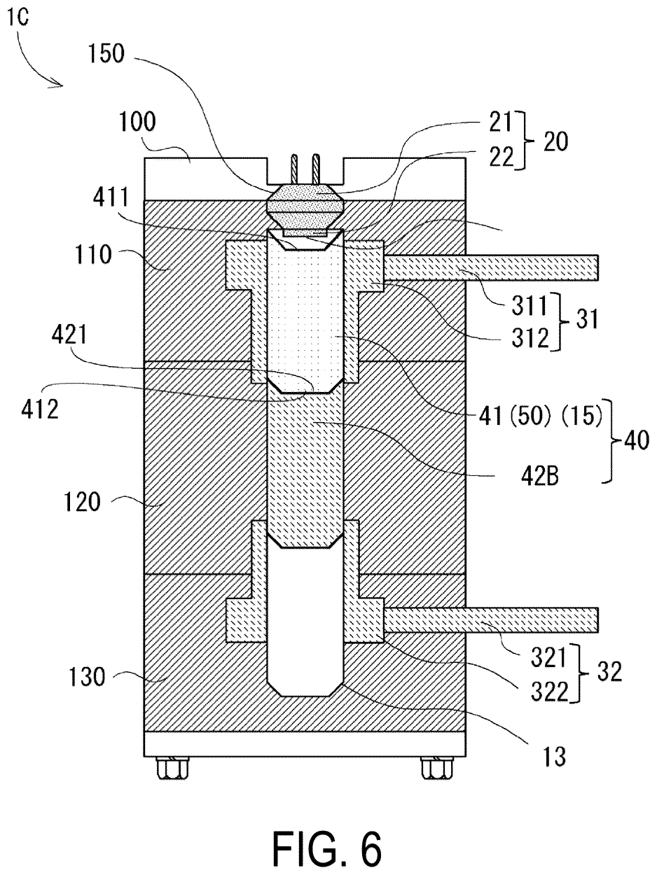

FIG. 6 is a longitudinal cross-sectional view of a breaker device 1C according to Modified Example 3 of the embodiment. FIG. 6 illustrates a schematic structure of the breaker device 1C from a lateral view. Hereinafter, the breaker device 1C according to Modified Example 3 of the embodiment will be described with reference to FIG. 6. Note that, in the description of the present Modified Example, description will be given of differences from the breaker device 1 described with reference to FIGS. 1 to 3. In addition, among members included in the breaker device 1C, the same members as those of the breaker device 1 are denoted by the same reference numerals, and a detailed description thereof will be omitted.

In the breaker device 1C according to Modified Example 3, a third accommodating space 15, which is a “predetermined region” according to the present disclosure, is formed in the piston 41 included in the projectile 40. In FIG. 6, the arc-extinguishing material 50 is disposed in the third accommodating space 15 included in the piston 41. However, the third accommodating space 15 may be disposed in a part of the piston 41, or the entirety of the third accommodating space 15 may be constituted by the piston 41. More specific examples thereof include an aspect in which the third accommodating space 15 is included in a part of the piston 41 such as its periphery or the inside thereof, and an aspect in which the piston 41 is constituted by the arc-extinguishing material 50. Note that, the aspect illustrated in FIG. 6 is an example, and the aspects of the third accommodating space 15 and the arc-extinguishing material 50 in the breaker device 1C are not limited thereto.

### Operation

In the breaker device 1C configured as described above, the energy generated at a time of actuation of the igniter 20 is received by the dent portion 411 of the piston 41. At this time, the rod 42 is pushed down to interrupt the electric circuit, and by the impact at a time of actuation of the breaker device 1C, the arc-extinguishing material 50 is released from the second accommodating space 14 formed in the piston 41, thereby conducting quenching of an arc that occurs in the rod 42 and the current-carrying portion 30 and cooling the gas generated from the igniter 20.

While the embodiments according to the present disclosure have been described above, each aspect disclosed in the present specification can be combined with any other feature disclosed in the present specification.

### REFERENCE SIGNS LIST

1 Electric circuit breaker device
10 Housing
20 Igniter
30 Current-carrying portion
40 Projectile
50 Arc-extinguishing material

1. An electric circuit breaker device comprising:
a housing;
an igniter provided in the housing;
a first accommodating space formed inside the housing and extending in one direction;
a projectile including a conductive member having electrical conductivity, the projectile being positioned at a first position in the first accommodating space before actuation of the igniter and configured to be projected, by energy received from the igniter at a time of actuation of the igniter, in a predetermined projecting direction along the first accommodating space;
a pair of current-carrying portions provided in the housing and forming a portion of an electric circuit, the pair of current-carrying portions being disposed such that the pair of current-carrying portions are electrically connected via the conductive member of the projectile positioned at the first position before actuation of the igniter and an electrical connection is disconnected when the igniter is actuated and the projectile is projected; and
an arc-extinguishing material disposed in a predetermined region before actuation of the igniter,
wherein the electric circuit breaker device is configured such that, at a time of actuation of the igniter, the arc-extinguishing material is released from the predetermined region by an impact caused when the projectile is projected and at least a part of the projectile is covered with the arc-extinguishing material released.

2. The electric circuit breaker device according to claim 1, comprising:
a second accommodating space formed, as the predetermined region, outside the first accommodating space and provided inside the housing; and
a first communicating portion via which the first accommodating space and the second accommodating space are in communication with each other,
wherein before actuation of the igniter, the first communicating portion is closed by the projectile positioned at the first position, and
,the first communicating portion opens when the projectile is projected by actuation of the igniter, and the arc-extinguishing material is released from the second accommodating space into the first accommodating space.

3. The electric circuit breaker device according to claim 2, further comprising:
a second communicating portion via which the second accommodating space and a region of the first accommodating space on a front side of the projectile in the projecting direction are in communication with each other.

4. The electric circuit breaker device according to claim 1,
wherein when the projectile is projected by actuation of the igniter, the arc-extinguishing material is accommodated in a region of the first accommodating space on a rearward side of the projectile in the projecting direction.

5. The electric circuit breaker device according to claim 1,
wherein the pair of current-carrying portions are disposed apart from each other in the projecting direction,
a first current-carrying portion of the pair of current-carrying portions on a rearward side in the projecting direction includes a first socket having a tubular shape and extending along the projecting direction,
a second current-carrying portion of the pair of current-carrying portions on a front side in the projecting direction includes a second socket having a tubular shape and extending along the projecting direction,
the first accommodating space is defined by the first socket and the second socket, and
before actuation of the igniter, the projectile is fitted into the first socket and the second socket such that the first socket and the second socket are electrically connected via the conductive member.

6. The electric circuit breaker device according to claim 5,
wherein before actuation of the igniter, the conductive member is press-fitted into at least one of the first socket or the second socket.

7. The electric circuit breaker device according to claim 5,
wherein before actuation of the igniter, the conductive member is bonded to at least one of the first socket or the second socket.

8. The electric circuit breaker device according to claim 5,
wherein before actuation of the igniter, at least one of the first socket or the second socket is integrally connected to the conductive member.

9. The electric circuit breaker device according to claim 1,
wherein the projectile includes a piston disposed on a rearward side of the conductive member in the projecting direction, the piston being configured to be projected in the projecting direction by energy received from the igniter at a time of actuation of the igniter.

10. The electric circuit breaker device according to claim 9,
wherein the predetermined region is included in the piston.

11. The electric circuit breaker device according to claim 1,
wherein the arc-extinguishing material is formed of an inorganic oxide.

12. The electric circuit breaker device according to claim 1,
wherein the arc-extinguishing material is formed of zeolite.
